(19) United States
(12) Patent Application Publication
(10) Pub. No.: US 2017/0011478 A1
(43) Pub. Date: Jan. 12, 2017

(54) Building Inspection System

(71) Applicant: Environmental Analysis Inc., Chicago, IL (US)

(72) Inventors: Sara Muñoz-Abramowicz, Chicago, IL (US); Peter Dennis, South Holland, IL (US)

(73) Assignee: Environmental Analysis Inc., Chicago, IL (US)

(21) Appl. No.: 15/137,847

(22) Filed: Apr. 25, 2016

Related U.S. Application Data
(60) Provisional application No. 62/189,833, filed on Jul. 8, 2015.

(51) Int. Cl. G06Q 50/16; G06Q 30/00

(52) U.S. Cl. CPC G06Q 50/163; G06Q 30/018

(57) ABSTRACT

Systems, methods, and devices execute techniques including providing, by a computing device, a user interface that allows a user to record inspection information. Further, embodiments include entering inspection information in an interactive data structure as well as receiving a laboratory sample analysis of suspect materials in a lab report data structure. In addition, embodiments include generating a table of identified suspect materials in a table data structure based on the HA information in the interactive data structure and the laboratory sample analysis in the lab report data structure. Moreover, embodiments include compiling a final report in a final report data structure based on the entered inspection information, the laboratory sample analysis and table of identified suspect materials as well as generating chain of custody report in a chain of custody data structure.

### RELATED APPLICATIONS

The present application claims priority to U.S. Provisional Patent Application No. 62/152,161 and U.S. Provisional Patent Application No. 62/189,833, both of which applications are herein incorporated by reference in their entireties for all that that they show, teach and suggest, without exclusion of any part thereof.

### TECHNICAL FIELD

The present disclosure is related generally to portable inspection assistance devices, and, more particularly, to a system and method for assisting with report generation for building inspection processes.

### BACKGROUND

Although it is known to inspect buildings for problems in materials and conditions, and it is known to report the findings of such inspections, it is currently difficult and time-consuming for the inspectors to generate such reports in an accurate and timely manner. Moreover, there is no guarantee that the inspector will remember to undertake all necessary inspection activities or collect all necessary information while at the inspection site.

Inspecting buildings can be a time consuming process, especially for large apartment/residential, commercial or government buildings. Building inspection may be needed by a prospective buyer prior to purchase for the purposes of evaluating the quality of the building or to evaluate the building for renovations and compliance to building codes. An inspection for large buildings may include inspecting each room in a building, measuring the dimensions of the room, determining the different surfaces or subsurfaces of each room (e.g., paint, drywall, carpet, hardwood floor, etc.), evaluating the quality and quantity of each surface and subsurface, and possibly taking a sample of some or all of the surfaces and subsurfaces to determine whether any regulated or dangerous material are contained therein.

Thus, for a large building, such as a school with many classrooms and common rooms (e.g. cafeteria, gymnasium, auditorium, etc.), an inspection can be time consuming and tedious. Further, after conducting an inspection and taking copious notes, the inspector must then return to the office and write an inspection report for the building owner or prospective buyer which can also be a time consuming and tedious endeavor. In addition, samples of surface and subsurfaces may be sent to an offsite laboratory for testing for regulated or dangerous materials. Results of such testing may be sent to the office of the inspector and often need to be integrated into the inspection report.

Conventional software programs do not have any features to streamline or improve the ease and efficiency of this process. Thus, an inspector may use a tablet computer or laptop computer to record inspection data using such a computer as a notepad and then return to the office to manually create reports using an office computer. Such a process may take weeks for large buildings. Thus there is a need for techniques and systems for more efficiently inspecting buildings and generating inspection reports.

While the present disclosure is directed to a system that can eliminate certain shortcomings noted in or apparent from the above, it will be appreciated that such a benefit is neither a limitation on the scope of the disclosed principles nor of the attached claims, except to the extent expressly noted in the claims. Additionally, the discussion in this Background section is reflective of the inventors' own observations, considerations, and thoughts, and is not intended to catalog or summarize any item of prior art. As such, the inventors expressly disclaim this section as admitted or assumed prior art. Moreover, the identification or implication herein of a desirable course of action reflects the inventors' own observations and ideas, and therefore cannot be assumed to indicate an art-recognized desirability.

### SUMMARY

In keeping with an embodiment of the disclosed principles, a system is provided for assisting a building inspector in inspecting a building, recording the inspection findings, and generating one or more required reports based on the inspection findings. In simplified overview, the disclosed system is implemented, in an embodiment, via a web application accessible on an inspector's portable device, the web application providing a number of guide interfaces to allow the inspector to identify certain salient property features, enter textual data and photographical data, and generate reports for further use.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Embodiments of the present disclosure include systems, methods, and devices include providing, by a computing device, a user interface that allows a user to record inspection information. Further, embodiments include entering inspection information in an interactive data structure as well as receiving a laboratory sample analysis of suspect materials in a lab report data structure. In addition, embodiments include generating a table of identified suspect materials in a table data structure based on the HA information in the interactive data structure and the laboratory sample analysis in the lab report data structure. Moreover, embodiments include compiling a final report in a final report data structure based on the entered inspection information in the interactive data structure, the laboratory sample analysis in the lab report data structure, and table of identified suspect materials in the table data structure as well as generating chain of custody report in a chain of custody data structure based entered inspection information in the interactive data structure.

Other features and aspects of embodiments of the disclosed principles will be appreciated from the detailed disclosure taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic view of an electronic computing device environment within which embodiments of the disclosed principles may be implemented;

FIG. 2 is an architectural application view showing functional modules as they relate to the mobile application in an embodiment of the disclosed principles;

FIG. 3 is a screenshot in accordance with an embodiment of the disclosed principles;

FIG. 4 is a screenshot in accordance with an embodiment of the disclosed principles;

FIG. 5 is a screenshot in accordance with an embodiment of the disclosed principles;

FIG. 6 is a screenshot in accordance with an embodiment of the disclosed principles;

FIG. 7 is a screenshot in accordance with an embodiment of the disclosed principles;

FIG. 8a is a screenshot in accordance with an embodiment of the disclosed principles;

FIG. 8b is a screenshot in accordance with an embodiment of the disclosed principles;

FIG. 9 is a screenshot in accordance with an embodiment of the disclosed principles;

FIG. 10 is a screenshot in accordance with an embodiment of the disclosed principles;

FIG. 11 is a screenshot in accordance with an embodiment of the disclosed principles;

FIG. 12 is a screenshot in accordance with an embodiment of the disclosed principles;

FIG. 13 is a screenshot in accordance with an embodiment of the disclosed principles;

FIG. 14 is a screenshot in accordance with an embodiment of the disclosed principles;

FIG. 15 is a screenshot in accordance with an embodiment of the disclosed principles;

FIG. 16 is a screenshot in accordance with an embodiment of the disclosed principles;

FIG. 17 is a screenshot in accordance with an embodiment of the disclosed principles;

FIG. 18 is a screenshot in accordance with an embodiment of the disclosed principles;

FIG. 19 is a screenshot in accordance with an embodiment of the disclosed principles;

FIG. 20 is a screenshot in accordance with an embodiment of the disclosed principles;

FIG. 21 is a screenshot in accordance with an embodiment of the disclosed principles;

FIG. 22 is a screenshot in accordance with an embodiment of the disclosed principles;

FIG. 23 is a screenshot in accordance with an embodiment of the disclosed principles;

FIG. 24 is a screenshot in accordance with an embodiment of the disclosed principles;

FIG. 25 is a screenshot in accordance with an embodiment of the disclosed principles;

FIG. 26 is a screenshot in accordance with an embodiment of the disclosed principles;

FIG. 27 is a screenshot in accordance with an embodiment of the disclosed principles; and

FIG. 28 is a screenshot in accordance with an embodiment of the disclosed principles.

### DETAILED DESCRIPTION

As noted above, the formal inspection of buildings for problems in materials and conditions, including preparing necessary reports of inspection findings is currently a difficult and time-consuming task. The disclosed principles provide a system for assisting a building inspector in inspecting a building, recording the inspection findings, and generating one or more required reports based on the inspection findings. The disclosed system may be implemented in a web application accessible on an inspector's portable device in conjunction with the primary storage and administrative functionality of the system as provided from a server and other hardware over a network.

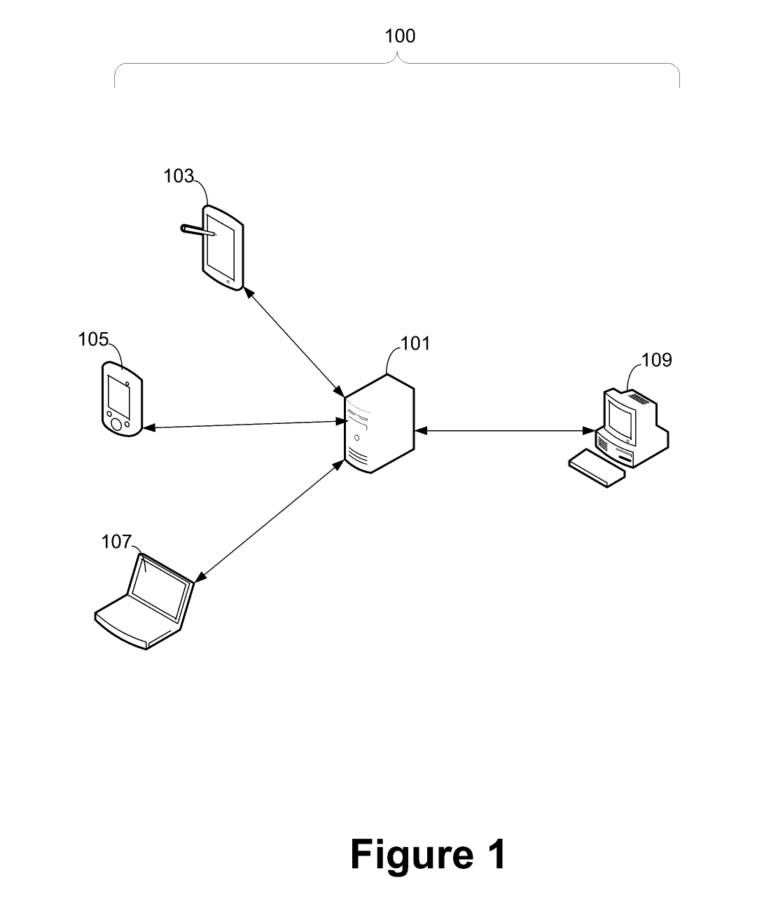

With this overview in mind, and turning now to a more detailed discussion in conjunction with the attached figures, the techniques of the present disclosure are illustrated as being implemented in a suitable computing and network environment. FIG. 1 shows an example of such an environment. In particular, the illustrated example 100 includes a server 101 as well as numerous user devices 103, 105, 107 and an administrative device 109. It will be appreciated that a greater or lesser number of user devices may be used and that more than one administrative device may be used, especially if there are numerous administrators in a system.

Each of the user devices 103, 105, 107 and the administrative device 109 may be any portable or stationary computing device capable of communicating electronically, e.g., via a wired or wireless network. Each user device 103, 105, 107 should also have user interface capabilities such that its user may observe information, e.g., on a screen of the device, and may input information, e.g., via a virtual or physical device key board.

In an embodiment, the collection of user devices 103, 105, 107 includes one or more of a smartphone device, a laptop device, a desktop PC, and a tablet. The administrative device 109 may also be any of these device types.

Each device has memory, e.g., RAM and ROM, and a processing unit, and executes computer-implemented tasks by retrieving computer-executable instructions from a non-transient computer-readable medium such as one or both of RAM and ROM or other memory structure, and executing the computer-executable instructions on the device processor. Thus, for example, the later flowcharts herein will refer to steps, and it will be appreciated that those steps which are computer-implemented on a device are executed in the above manner.

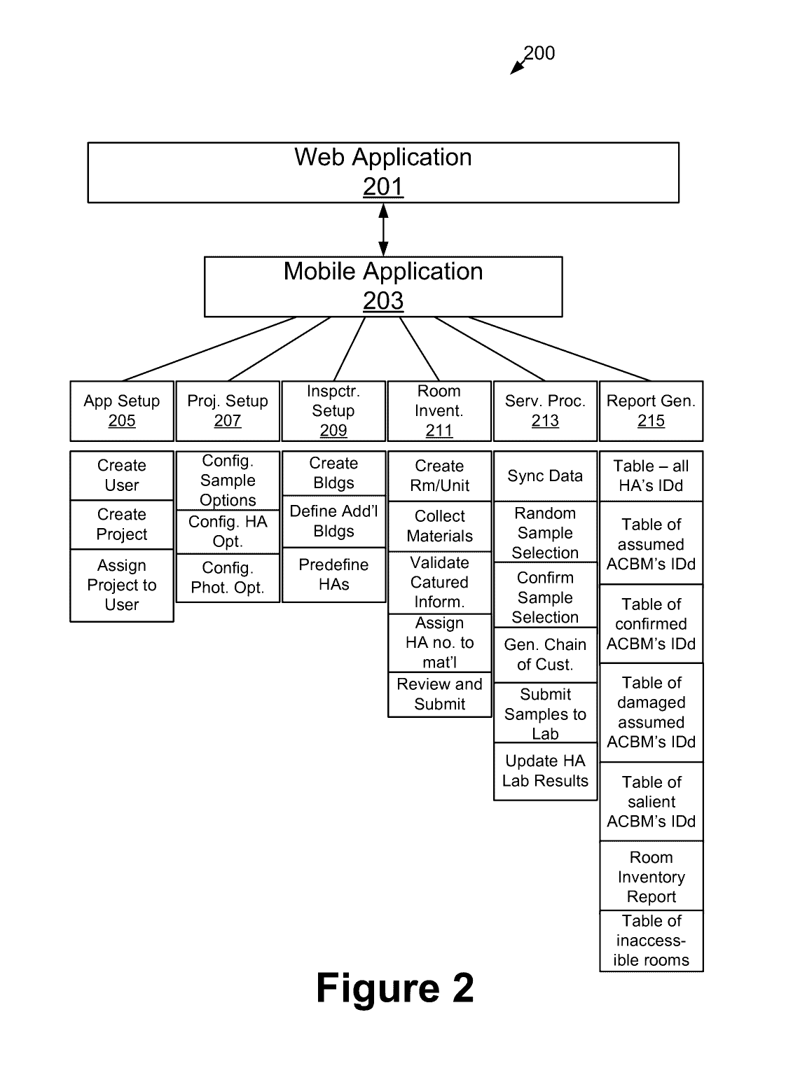

FIG. 2 is an architectural application view showing functional modules as they relate to the mobile application in an embodiment of the disclosed principles. In particular, the web application 201 and mobile application 203 interface over a network or group of networks such as one or more of the internet, a local WiFi network, a cellular network, a LAN, a WAN and so on.

The mobile application 203 exposes a plurality of modules to a user of the mobile device, e.g., a building inspector. The exposed modules include modules for application setup 205, project setup 207, inspector setup 209, room inventory 211, server processing 213 and reports 215. Each of these modules supports a number of functions, as shown. Thus, for example, the application setup module 205 provides an interface for creating a user account, creating a project, and assigning the project to the user. The project setup module 207 provides an interface for configuring sample options, configuring HA options, configuring photo options and configuring damage options.

The inspector setup module 209 allows the user to create buildings, define building additions and predefine damage options, and the room inventory module 211 provides an interface to create rooms and units, as well as prompts to collect materials for all tabs, flooring, baseboard, wall, ceiling, mechanical, other, below floors, behind walls and above ceiling, in addition to prompts for validating information captured, assigning HA numbers to materials, reviewing and submitting.

Similarly, the server processing module 213 syncs the data, provides random sample selections, confirms sample selection, generates chain of custody labelling or information, prompts for lab submission and then updates the HA lab results.

Finally, the reports module 215 generates a plurality of tables and reports including a table of all HAs identified, a table of assumed ACBMs identified, a table of confirmed ACBMs identified, a table of damaged confirmed ACBMs identified, a table of salient ACBMs identified, a room inventory report and a table of inaccessible rooms.

With respect to administrative setup, an administrative user may either manage users or projects. If the user chooses to manage users, the user may access a user screen from the home page of the application, create a project, assign the project to a user, manage that user's projects and generate user project status information. If the user instead chooses to manage projects, they may access a projects screen from the home page, which allows the user to then configure project settings, create a room inventory, track sample inventory and chain of custody data and view laboratory results and resultant reports.

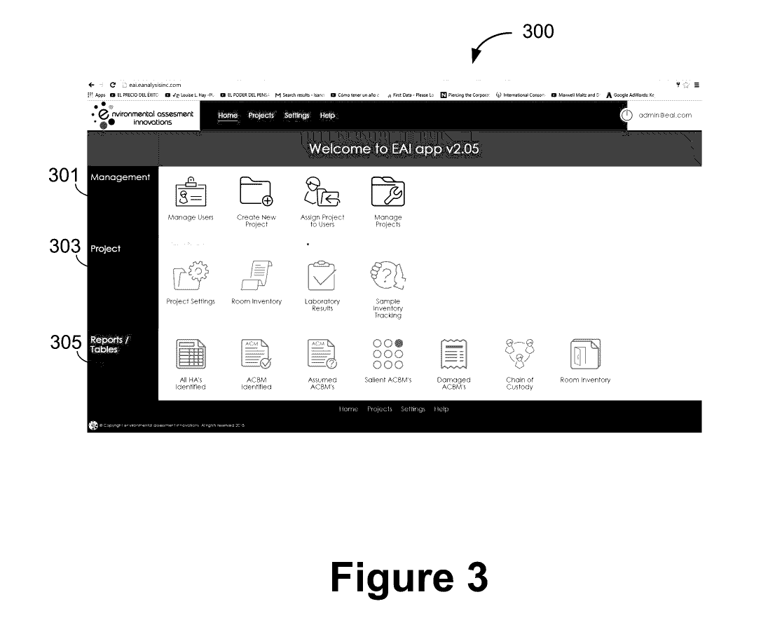

With respect to user interaction with the mobile application, FIG. 3 shows a simulated view of a home page landing screen 300. The landing screen 300 provides a number of selectable options including, for example, a management option 301, a project option 303 and a reports and tables option 305. The management option 301 allows the user to manage users and projects, while the project option 303 allows the user to execute specific projects, and the reports and tables option 305 allows the user to generate and view the various reports and tables created as described above.

The landing screen 300 also exposes links to “Projects,” “Settings,” and “Help.” If the user selects the “Settings” option, a settings page such as that shown in

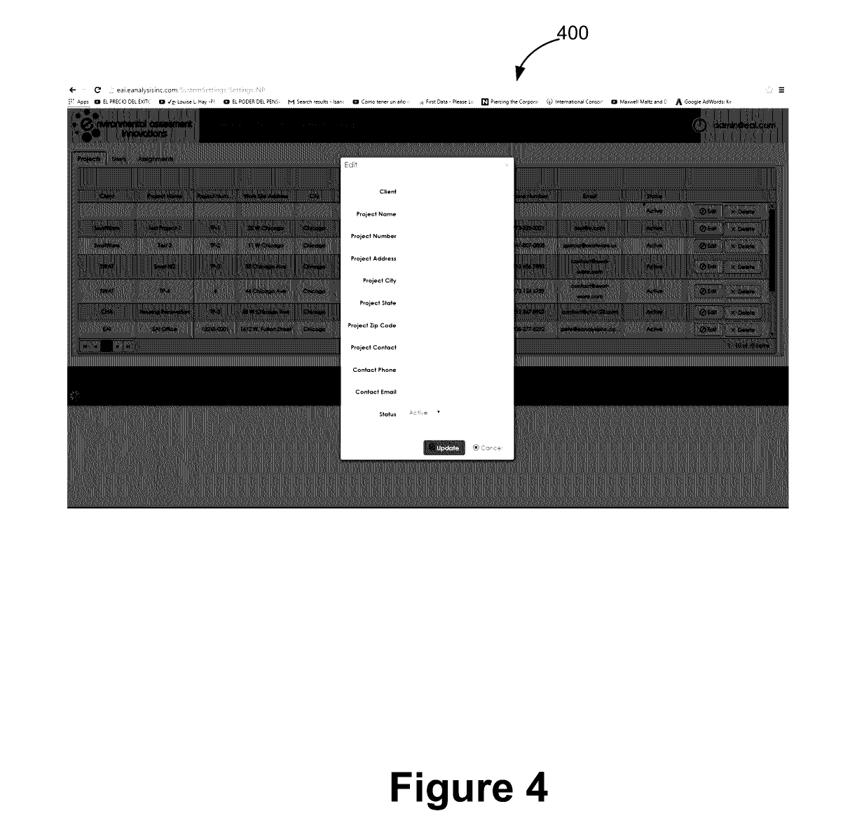

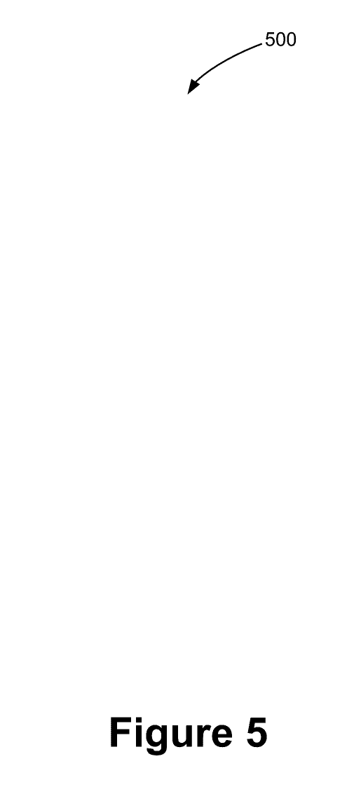

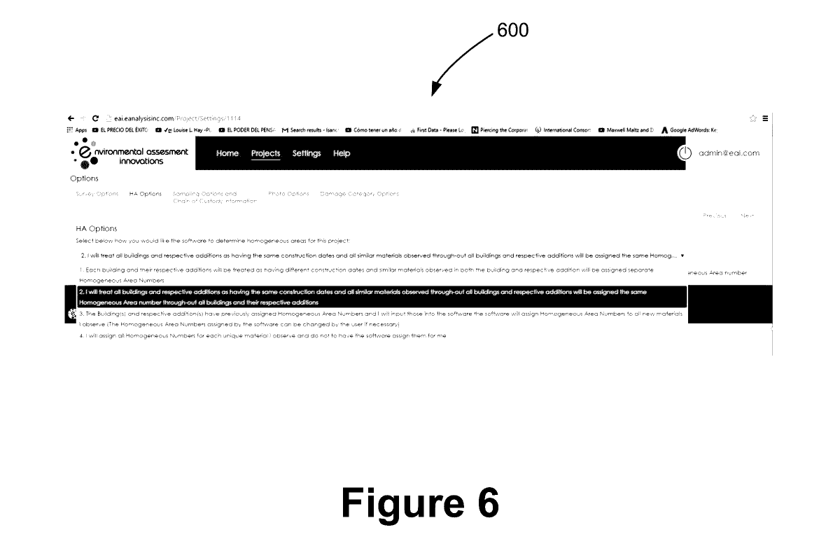

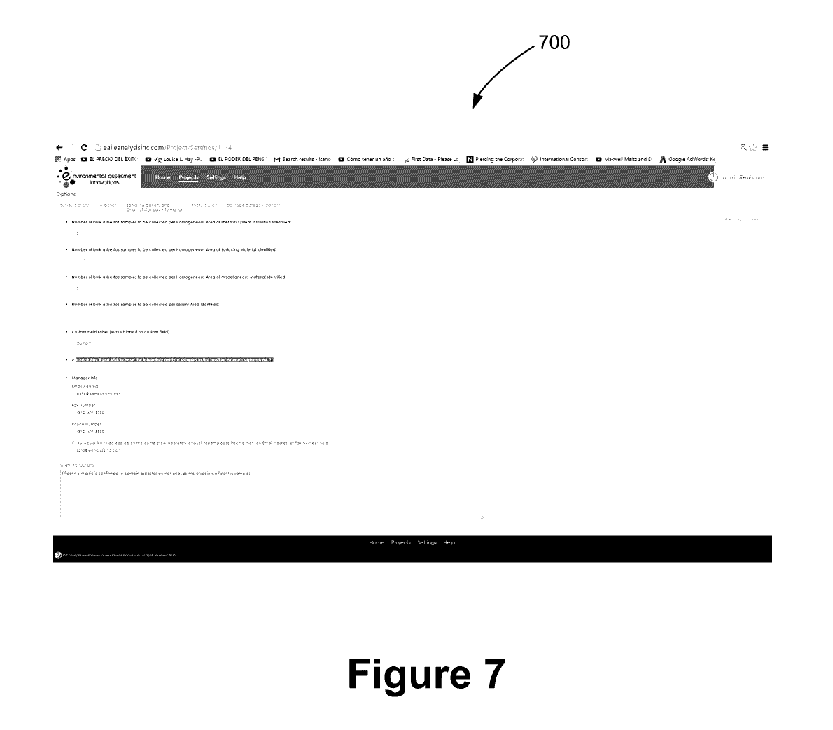

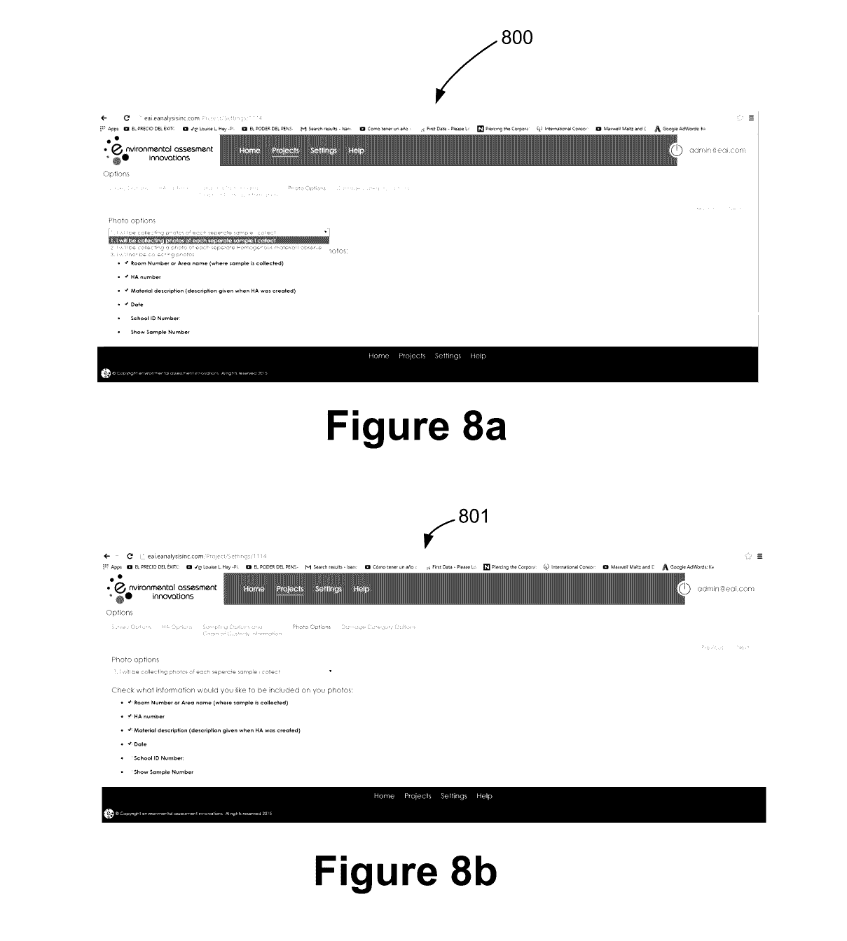

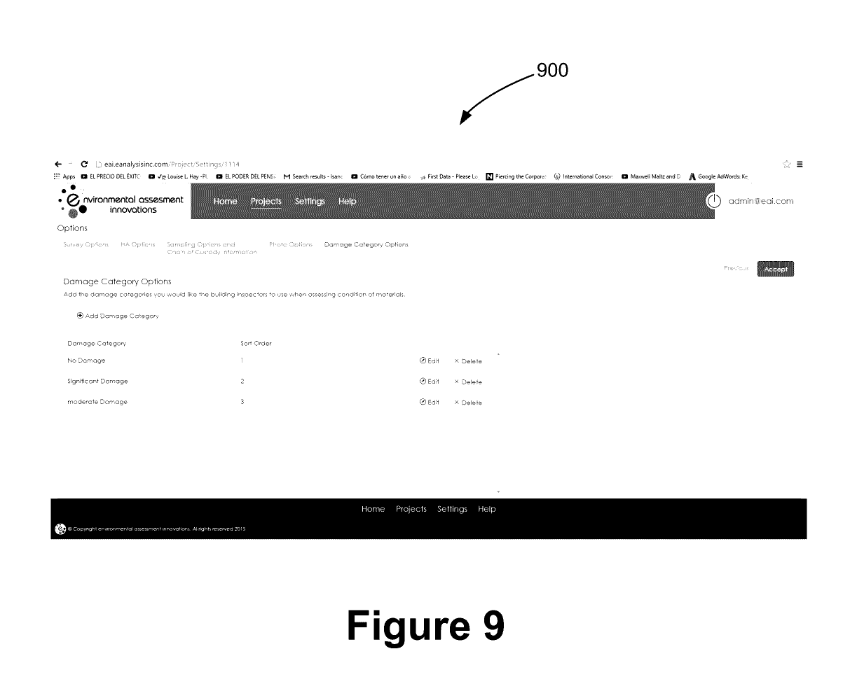

FIG. 4, screen 400 is displayed on the device. As can be seen, the settings screen allows the user to set or change the client, project name, project number, project physical address, project contact and the contacts number and email address if available. Similarly, the user may select the “Projects” option and will be shown a projects screen exposing tabs for Survey Options (FIG. 5, screen 500), HA Options (FIG. 6, screen 600), Sampling Options and Chain of Custody Information (FIG. 7, screen 700), and Photo Options (FIGS. 8a-8b, screens 800, 801) and Damage Category Options (FIG. 9, screen 900).

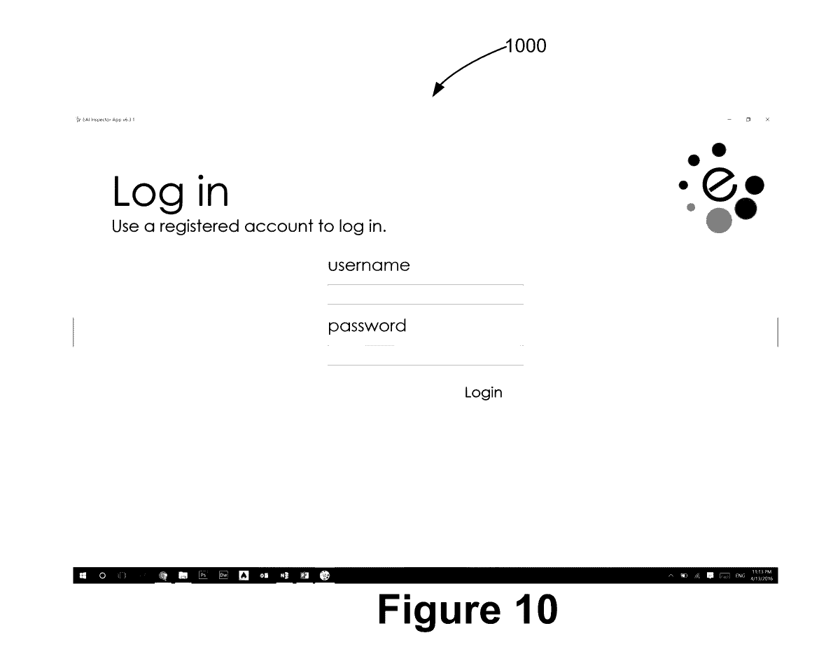

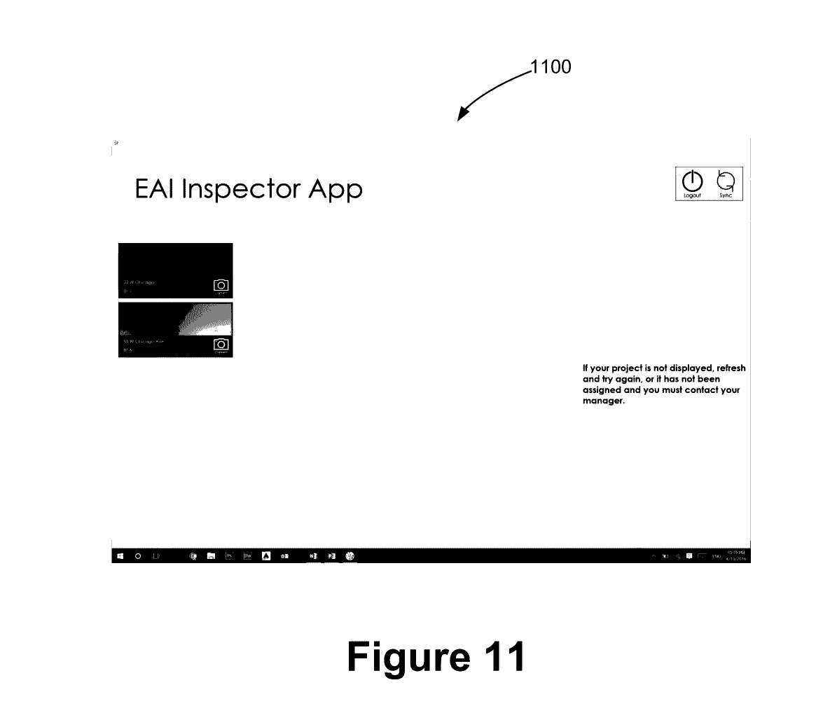

FIGS. 10-20 show screen shots of the mobile application as a user goes through and inspection process. Screen 1000 (FIG. 10) shows a Login screen for receiving the users username and password and screen 1100 (FIG. 11) shows an inspection project screen shown once the user has logged in.

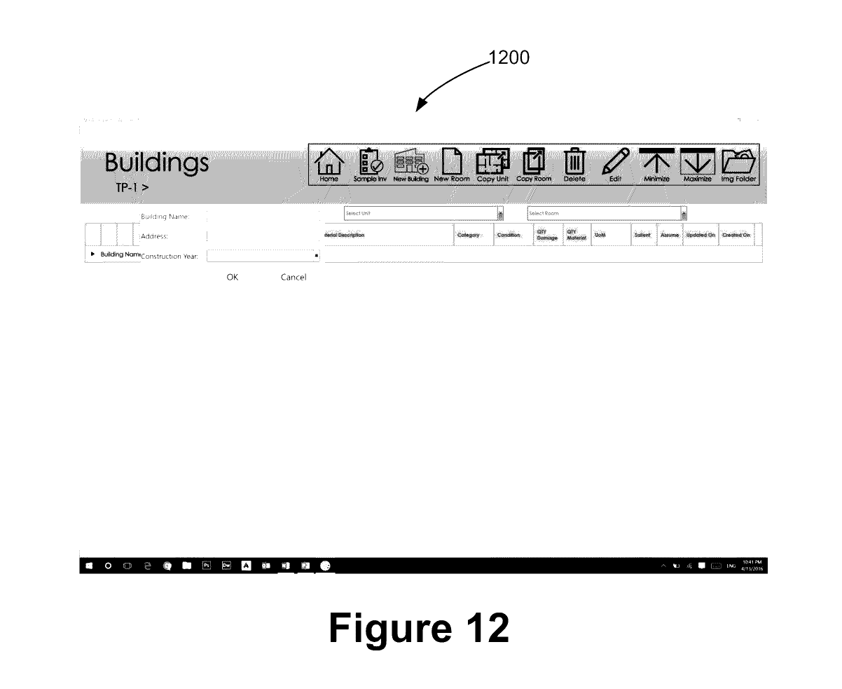

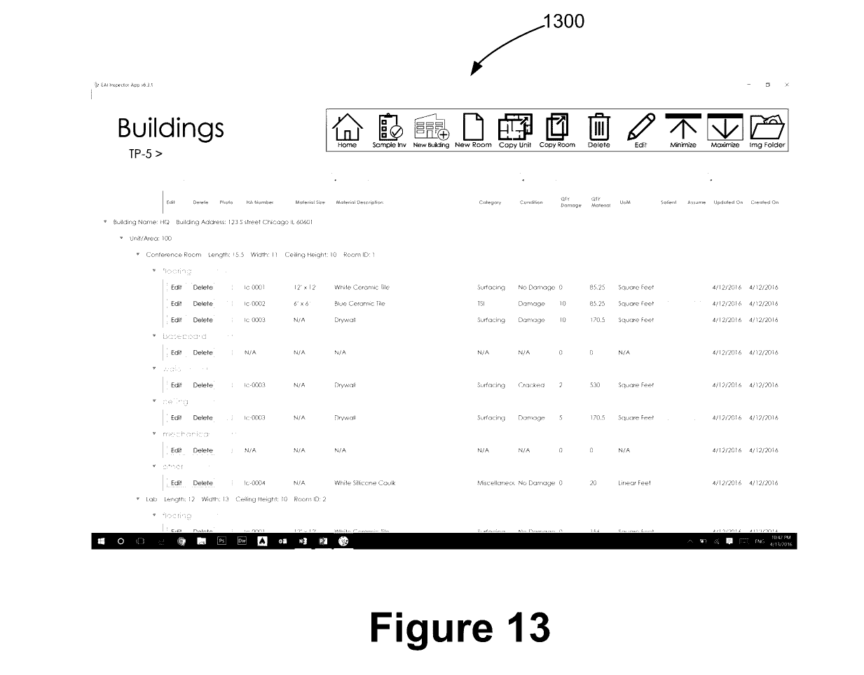

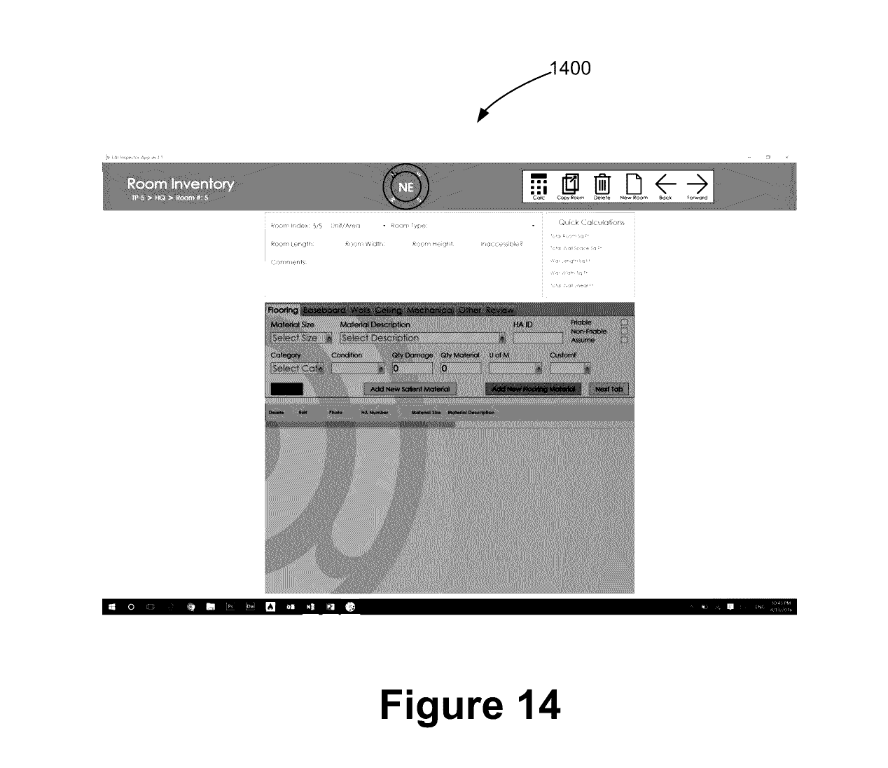

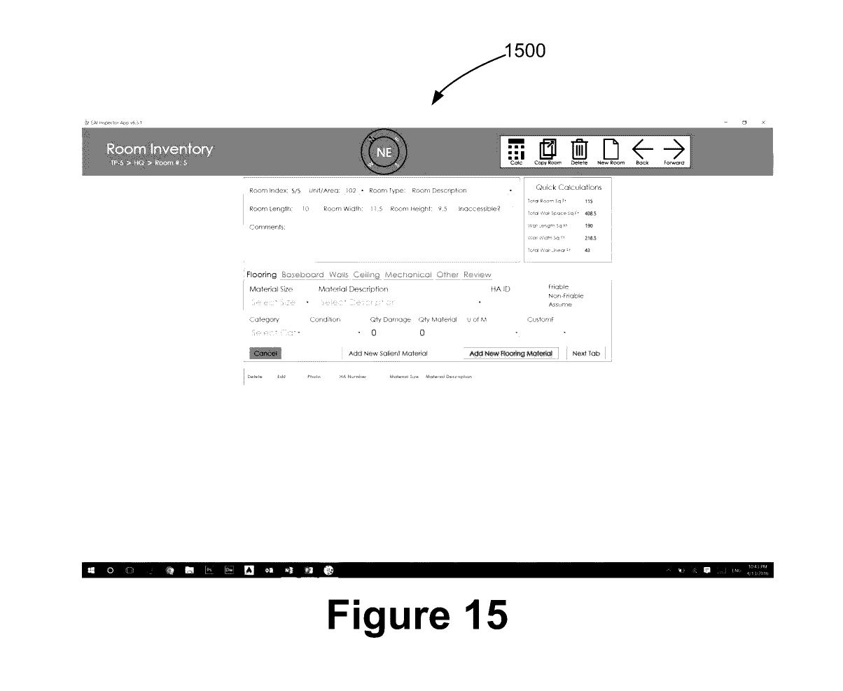

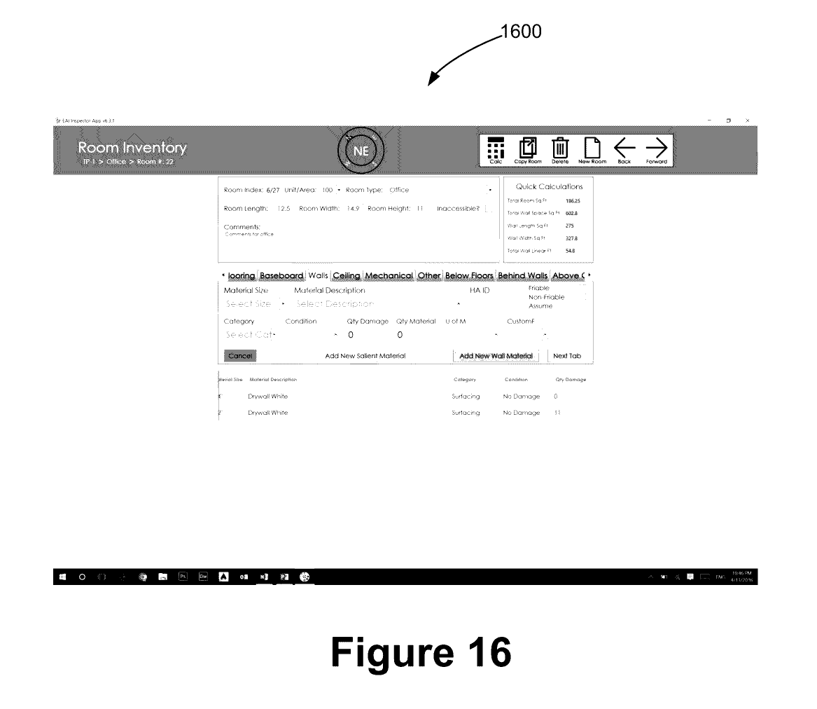

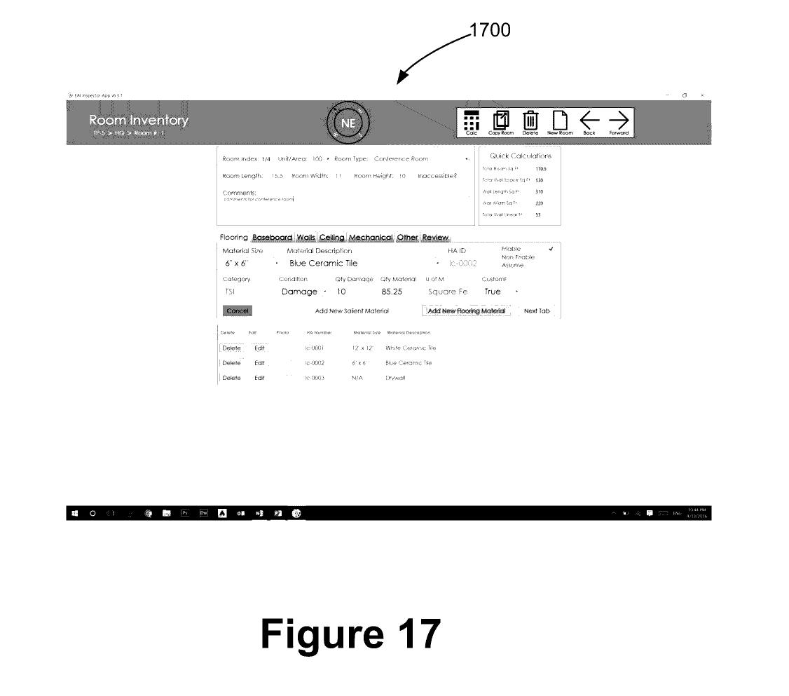

Screen 1200 (FIG. 12) shows the user creating a new building and screen 1300 (FIG. 13) then shows the user selecting building options. The user is then able to enter room inventory, creating a new room in the screen shot 1400 of FIG. 14, after which the room option tabs are enabled as shown in FIG. 15 (screen shot 1500) as are the exploratory demolition tabs (FIG. 16, screen shot 1600). The interface with no exploratory demolition is shown in FIG. 17, screen shot 1700.

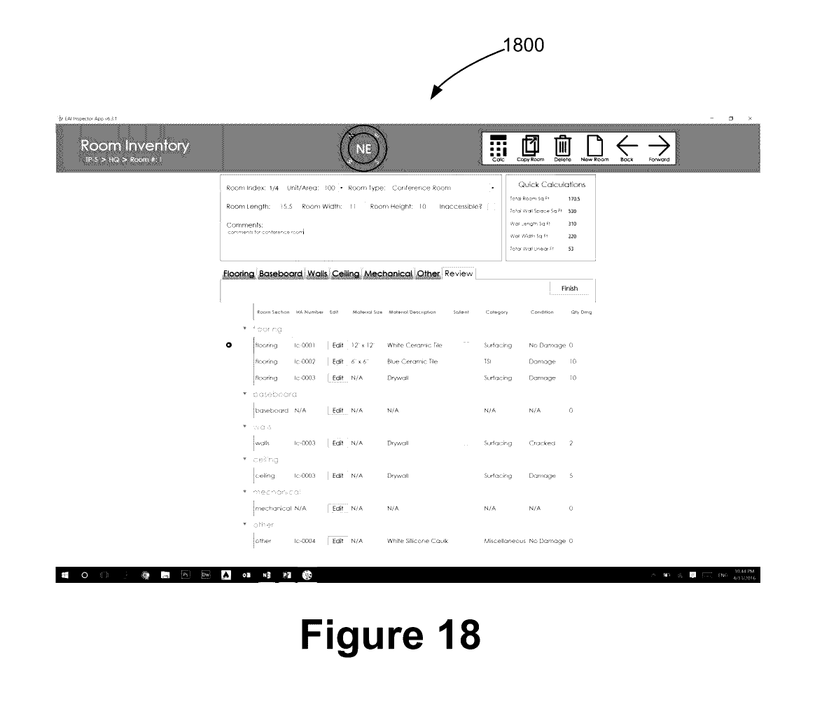

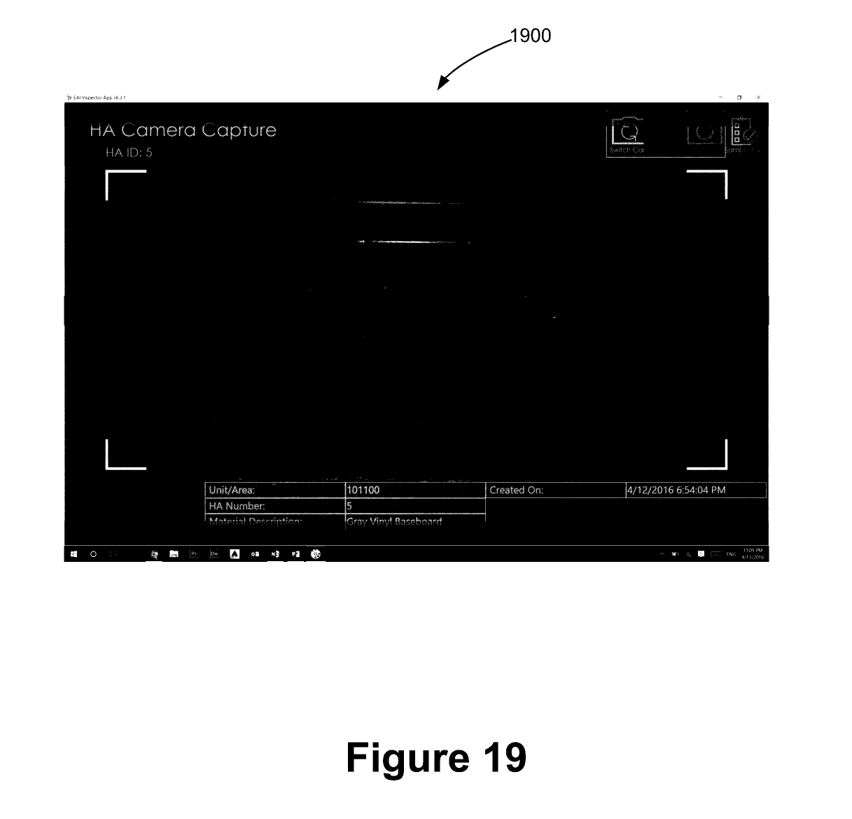

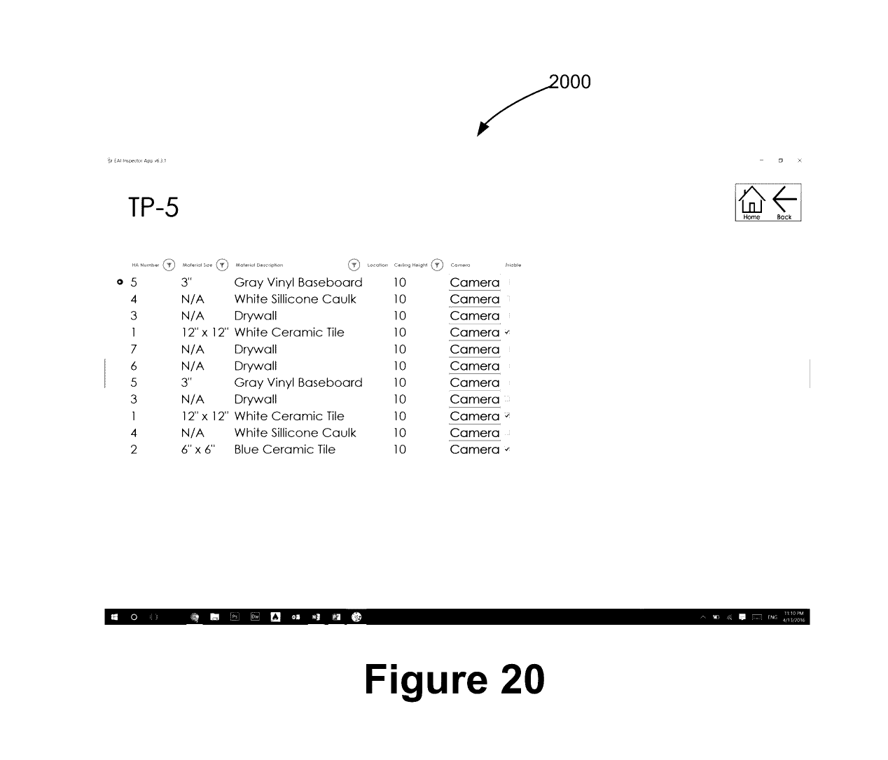

The user is able to review the input information via the review tab as shown in the screen shot 1800 of FIG. 18. The module application also works with the device's camera and phot functions to take photographs that are imported into the application as shown in FIG. 19, screen shot 1900. Finally, the sample inventory tab displays a sample inventory to the user as shown in FIG. 20, screen shot 2000.

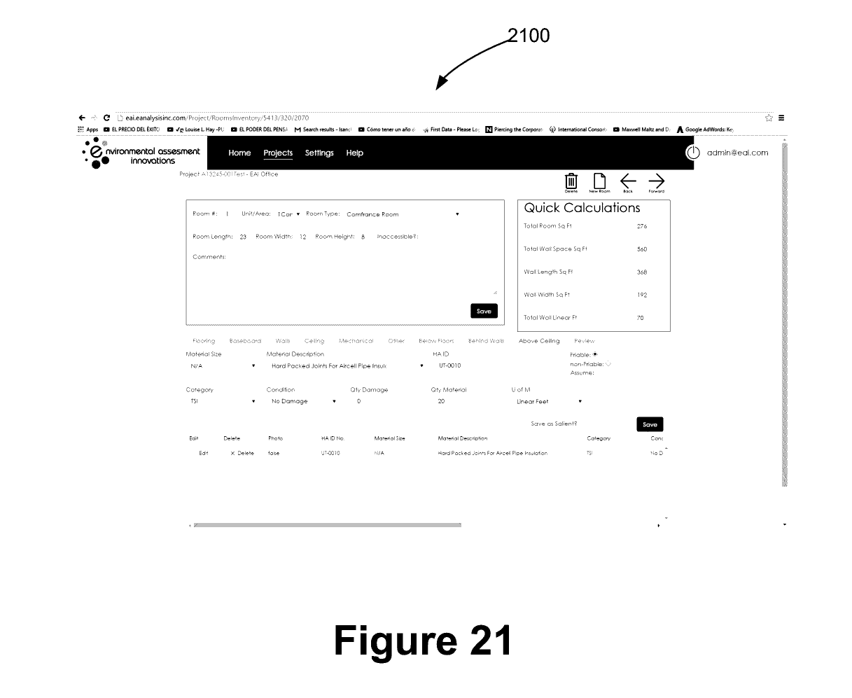

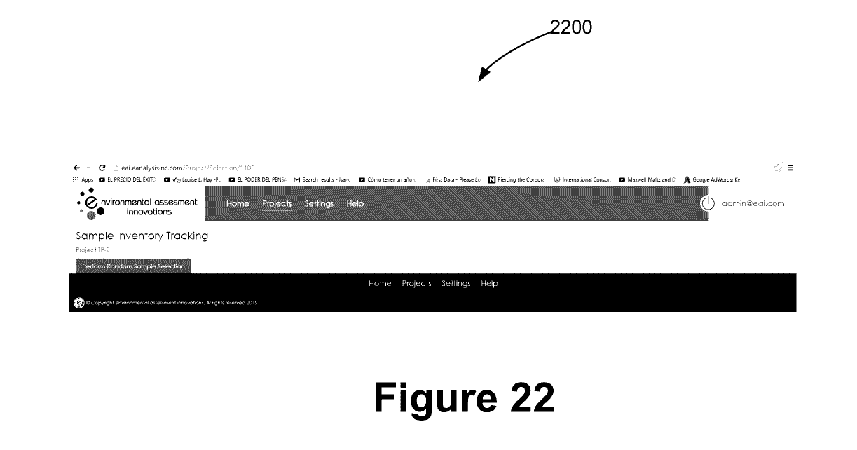

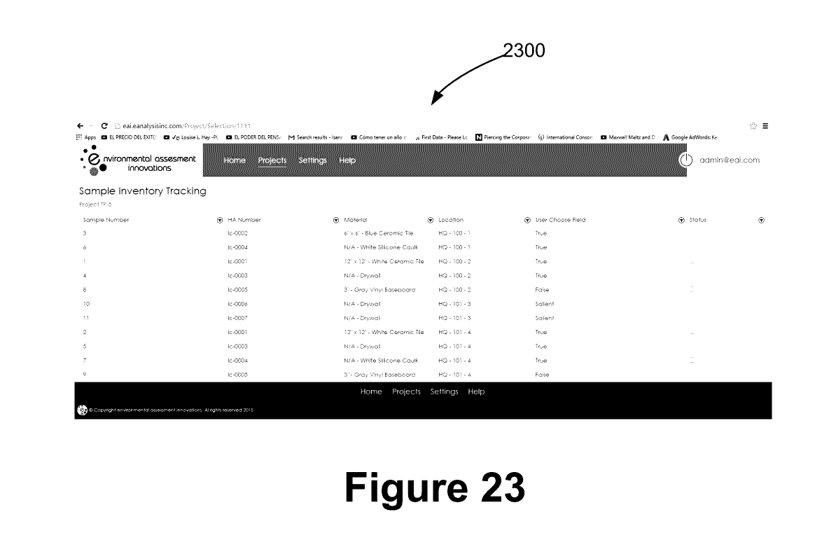

Once the room inventory is performed, the inspector is able to sync the data and perform the rest of the inspection process. Upon selecting the process thus established, the user is first shown a room inventory screen 2100 as shown in FIG. 21. The unpopulated sample inventory screen 2200 is shown in FIG. 22 while FIG. 23 shows a screen shot 2300 of the now populated inventory.

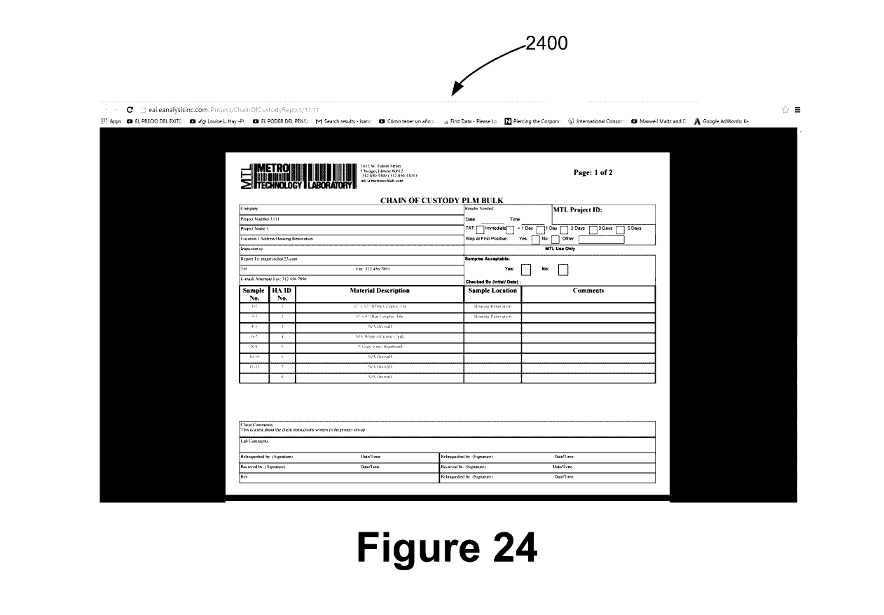

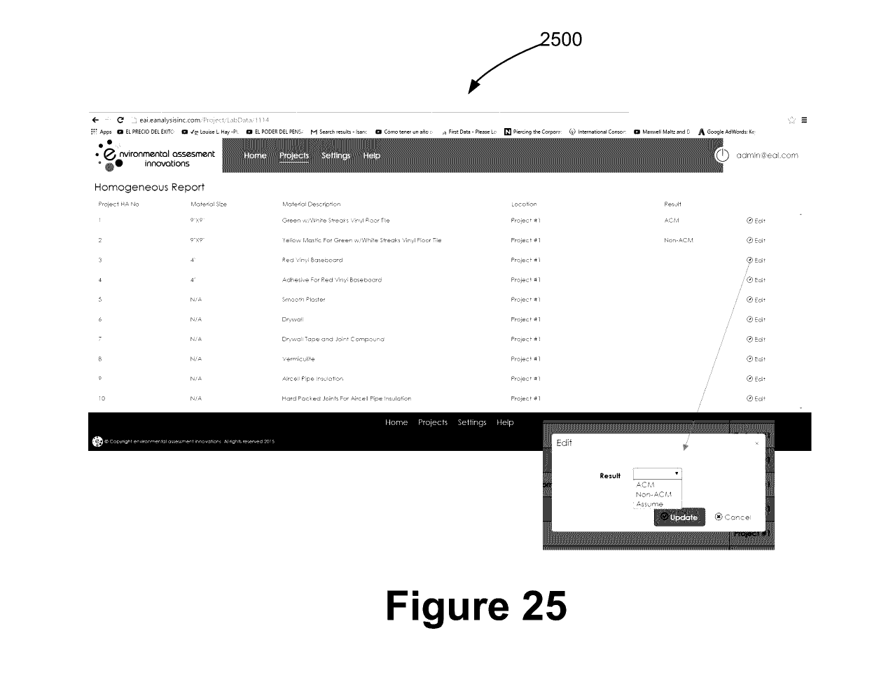

As noted above, the mobile application is configured to generate chain of custody labels for the user, and such a label is shown in screen view in the screen shot 2400 of FIG. 24. FIG. 25 (screen shot 2500) shows a homogenous lab report as generated by the mobile application after the data collection task is completed by the inspector. The illustrated screen shot 2500 shows the user selecting an edit option wherein the user may update the result type (ACM, non-ACM, assume).

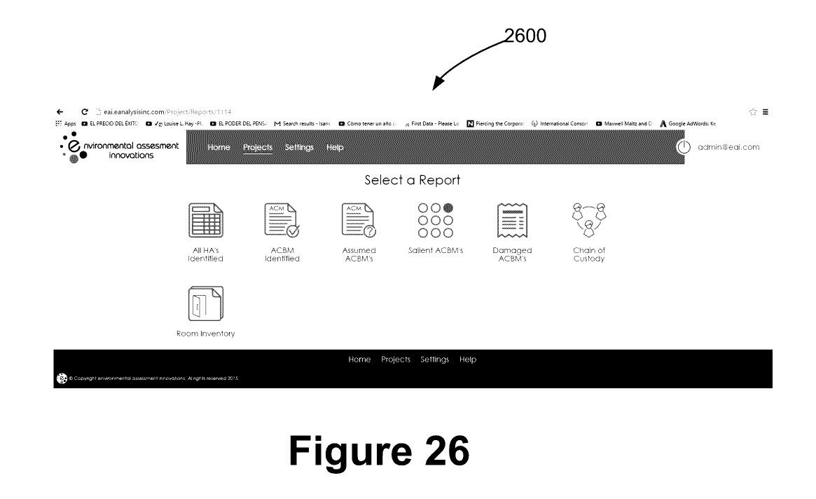

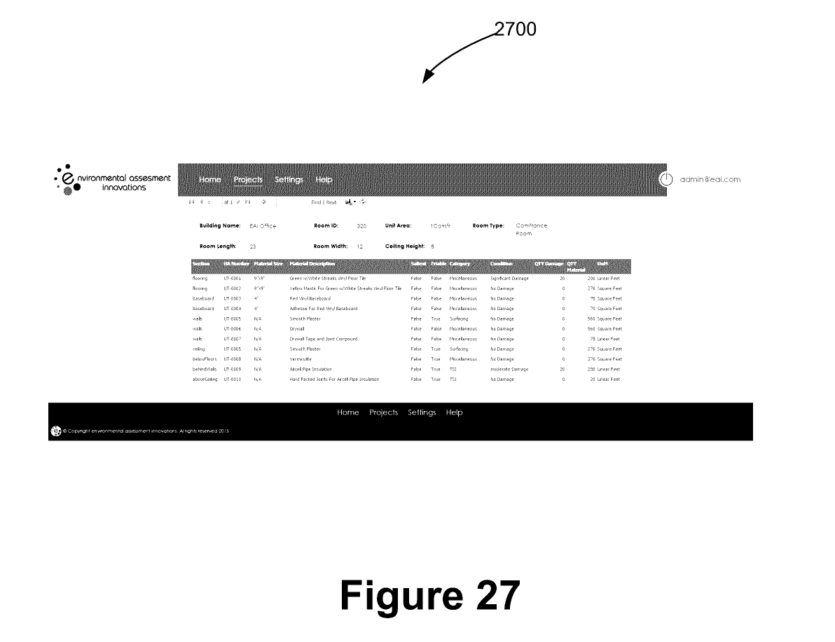

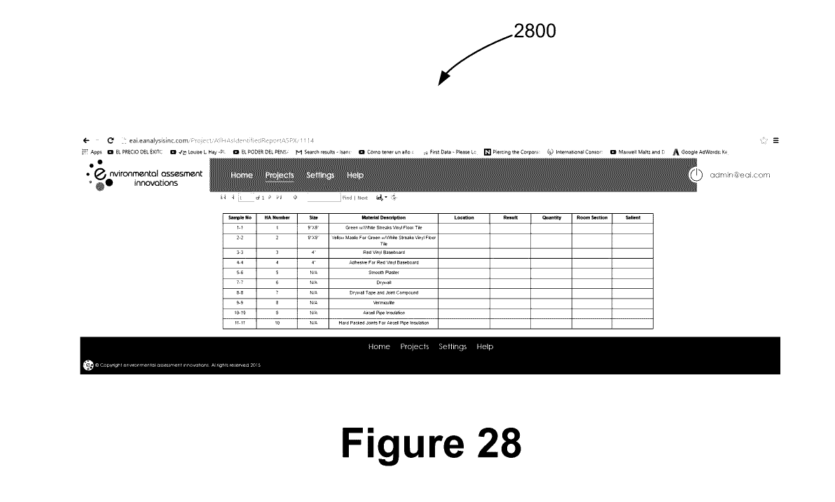

Turning to FIG. 26, this figure shows a screen shot 2600 showing available reports for a project, e.g., All HAs identified, ACBM identified, Assumed ACBMs, Salient ACBMs, Damages ACBMs, Chain of custody reports and room inventories. If the user selects the Room Inventory then a screen such as shown in screen shot 2700 (FIG. 27) is presented to the user. If the user instead selects All HAs identified, then a screen such as in screen shot 2800 (FIG. 28) is presented.

While providing more detailed screenshots corresponding to an implementation of the disclosed principles, several exemplary processes will be flowcharted to aid the reader. To this end, FIG. 2 shows a flow chart of a process 200 for @@@@

It will be appreciated that a system and method for improved building inspection report generation have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof

We claim:

1. A method for generating an inspection report relative to an inspection of a building performed by an inspector, the method comprising:
(a) providing at a portable computing device a user interface configured for a user to record inspection information;
(b) receiving at the portable computing device inspection information entered by the user;
(c) receiving a laboratory sample analysis of suspect materials in a lab report data structure;
(d) generating an inspection report including a table of identified materials in a table data structure based on the inspection information entered by the user and the laboratory sample analysis.

2. The method of claim 1, wherein the inspection information is at least one of sample information, homogenous area (HA) information, client information, project information, room information, building information, chain of custody information, and main report information.

3. The method of claim 1, wherein generating an inspection report further comprises compiling a final report in a final report data structure based on the entered inspection information, compiling the laboratory sample analysis in the lab report data structure, and compiling the table of identified suspect materials in the table data structure.

4. The method of claim 1, further comprising generating chain of custody report in a chain of custody data structure based entered inspection information in the interactive data structure.

5. The method of claim 1, wherein the room information is at least one of flooring material information, baseboard information, wall material information, ceiling material information pipe insulation information, other material information, and mechanical material information.

6. The method of claim 1, wherein the table of suspect materials includes at least one of a HA number assigned to each identified material, list of collected samples, and list of samples submitted to laboratory for analysis.

7. The method of claim 3, wherein the final report includes at least one of an asbestos survey, summary of asbestos containing material (ACM), table of suspect materials identified, table of confirming ACM, and table of suspect materials assumed to be ACM.

8. A device for generating an inspection report relative to an inspection of a building performed by an inspector, the device comprising:
(a) one or more storage modules;
(b) one or more processors coupled to the one or more storage modules;
(c) one or more program modules executed by the one or more processors; the program modules configured to:
(i) provide, by a computing device, a user interface that allows a user to record inspection information;
(ii) receive inspection information entered by the inspector in an interactive data structure;
(iii) receive a laboratory sample analysis of suspect materials in a lab report data structure;
(iv) generate an inspection report including a table of identified materials in a table data structure based on the inspection information entered by the user and the laboratory sample analysis.

9. The device of claim 8, wherein the inspection information is at least one of sample information, homogenous area (HA) information, client information, project information, room information, building information, chain of custody information, and main report information.

10. The device of claim 8, wherein the one or more modules are further configured to compile a final report in a final report data structure based on the entered inspection information in the interactive data structure, the laboratory sample analysis in the lab report data structure, and table of identified suspect materials in the table data structure.

11. The device of claim 8, wherein the one or more modules are further configured to generate chain of custody report in a chain of custody data structure based entered inspection information in the interactive data structure.

12. The device of claim 8, wherein the room information is at least one of flooring material information, baseboard information, wall material information, ceiling material information pipe insulation information, other material information, and mechanical material information.

13. The device of claim 8, wherein the table of suspect materials includes at least one of a HA number assigned to each identified material, list of collected samples, and list of samples submitted to laboratory for analysis.

14. The device of claim 10, wherein the final report includes at least one of an asbestos survey, summary of asbestos containing material (ACM), table of suspect materials identified, table of confirming ACM, and table of suspect materials assumed to be ACM.

15. A system for generating an inspection report relative to an inspection of a building performed by an inspector, the system comprising:
(a) a communication network;
(b) a computer server having:
(i) one or more server storage devices;
(ii) one or more server processors coupled to the one or more server storage devices;
(iii) one or more server modules executed by the one or more server processors;
(c) a user computing device having:
(i) one or more user storage devices;
(ii) one or more user processors coupled to the one or more server storage devices;
(iii) one or more user modules executed by the one of user processors, the user modules are configured to:
(A) provide, by a computing device, a user interface that allows a user to record inspection information;
(B) enter inspection information in an interactive data structure;
(d) wherein the computer server is coupled to one or more server modules configured to:
(i) receive entered inspection information;
(ii) receive a laboratory sample analysis of suspect materials in a lab report data structure; and
(iiii) generate a table of identified suspect materials in a table data structure based on the HA information in the interactive data structure and the laboratory sample analysis in the lab report data structure.

16. The system of claim 15, wherein the inspection information is at least one of sample information, homogenous area (HA) information, client information, project information, room information, building information, chain of custody information, and main report information

17. The system of claim 15, wherein the one or more server modules are further configured to compile a final report in a final report data structure based on the entered inspection information in the interactive data structure, the laboratory sample analysis in the lab report data structure, and table of identified suspect materials in the table data structure.

18. The system of claim 15, wherein the one or more server modules are further configured to generate chain of custody report in a chain of custody data structure based entered inspection information in the interactive data structure.

19. The system of claim 15, wherein the room information is at least one of flooring material information, baseboard information, wall material information, ceiling material information pipe insulation information, other material information, and mechanical material information.

20. The system of claim 15, wherein the table of suspect materials includes at least one of a HA number assigned to each identified material, list of collected samples, and list of samples submitted to laboratory for analysis.

21. The system of claim 15, wherein the final report includes at least one of an asbestos survey, summary of asbestos containing material (ACM), table of suspect materials identified, table of confirming ACM, and table of suspect materials assumed to be ACM.
